(19) United States
(12) Patent Application Publication
(10) Pub. No.: US 2026/0233866 A1
(43) Pub. Date: Aug. 13, 2026

(54) QUICK DETACH KEYED ROTARY DRIVE COUPLER FOR UNMANNED AERIAL VEHICLE

(71) Applicant: Performance Drone Works LLC, Huntsville, AL (US)

(72) Inventor: Dylan Thomas Hamm, Boise, ID (US)

(73) Assignee: Performance Drone Works LLC, Huntsville, AL (US)

(21) Appl. No.: 19/051,400

(22) Filed: Feb. 12, 2025

(51) Int. Cl. B64U 30/292; B64U 10/14; B64U 30/24; B64U 30/293

(52) U.S. Cl. CPC B64U 30/292; B64U 30/24; B64U 30/293; B64U 10/14

(57) ABSTRACT

Techniques are presented for rapidly installing and removing propeller assemblies of unmanned aerial vehicles. Coaxial motor drives allow a coaxial set of propeller assemblies to mount using a locking pin with a captive spring and handle for actuation of an engagement mechanism such as a ball or cam lock. A propellor or other effector mounting hub includes with features, such as a ramp or screw for example, to translate between locked and unlocked positions. The propeller assemblies drive are keyed to be mounted in correspondingly keyed motor assemblies by use of indexing features such as pins or other geometry to act as drive keying for the propeller assembly.

### BACKGROUND

Radio controlled unmanned aerial vehicles or UAVs (e.g. drones, such as quadcopters) can move at high speed and make rapid changes in direction when remotely piloted by a user. A drone may include a flight controller that provides output to motors and thus controls propeller speed to change thrust (e.g. in response to commands received from a user via a communication channel such as a Radio Frequency (RF) communication channel established between a user's remote-control and a drone). For example, a quadcopter has four motors, each coupled to a corresponding propeller above the motor, with propellers mounted to generate thrust substantially in parallel (e.g. their axes of rotation may be substantially parallel). The flight controller may change the speeds of the motors to change the orientation and velocity of the drone and the propellers may remain in a fixed orientation with respect to the chassis of the quadcopter (i.e. without changing the angle of thrust with respect to the quadcopter) and may have fixed-pitch (i.e. propeller pitch may not be adjustable like a helicopter propeller so that each motor powers a corresponding fixed-pitch propeller in a fixed orientation with respect to a drone chassis). In some cases, a UAV may carry a payload.

### SUMMARY OF THE DRAWINGS

FIG. 1 is an example of a UAV and remote control.

FIG. 2 is a simplified representation of some of the components for one embodiment of a UAV (quadcopter).

FIG. 3 shows an example of some components of a quadcopter.

FIG. 4 shows an example of a quadcopter with a payload.

FIG. 5 shows an example of a quadcopter with a payload.

FIG. 6 is a perspective view of an embodiment of an overall contra-rotating assembly mounted on drive fixture.

FIG. 7 is an image of an implementation of the embodiment of FIG. 6 when attached to a motor.

FIG. 8 is a detail of FIG. 7 with the propeller assembly removed from the motor.

FIG. 9 is a transparent view of assembly engaged with square drive shaft for a single propellor and single motor.

FIG. 10 is an image of the propeller hub and the drive hub elements when disengaged.

FIGS. 11A and 11B are respectively side and perspective views of an embodiment of the drive motor showing 4× lower index drive pins, square drive shaft, and recess in the shaft for locking pin engagement.

FIG. 12 is a perspective view of the assembly featuring square drive, locking pin, and twist to unlock T-handle pin with the lower blades and the portions of the assemble specific to the lower blades removed.

FIG. 13 is a perspective view of the twist lock pin in the “locked” position, held in place by captive wave spring and retaining ring.

FIG. 14 is a cutaway view of the assembly in the “unlocked” position.

FIG. 15 is a flow chart of an embodiment for operating of an unmanned aerial vehicle such as the quadcopter embodiments of FIGS. 1-5, with a quick detach keyed rotary drive coupler such as presented in FIGS. 6-14.

### DETAILED DESCRIPTION

Unmanned systems traditionally use multiple rotors connected by screws to attach propellers or folding propeller hubs to the drive system. This process necessitates tools, precise torque application, and consumes time. Moreover, rotors have directional requirements that align with the motor's drive direction. The following presents embodiment to solve this problem for both the mounting, indexing, and drive of an effector, such as in a folding propeller hub embodiment by incorporating specific keyed features for motor directionality and forming a strong mechanical lock resistant to vibration-induced loosening.

More specifically, coaxial motor drives allow a coaxial set of propeller assemblies to mount using a locking pin with a captive spring and handle for actuation of an engagement mechanism such as a ball or cam lock. A propellor or other effector mounting hub includes with features, such as a ramp or screw for example, to translate between locked and unlocked positions. The propeller assemblies drive are keyed to be mounted in correspondingly keyed motor assemblies by use of indexing features such as pins or other geometry to act as drive keying for the propeller assembly.

Aspects of the present technology may be implemented using a wide range of UAVs including, but not limited to drones (e.g. quadcopter drones). Such drones may be controlled by a user using a remote control device and/or may be controlled with little or no human input (e.g. using control circuits to fly a predetermined flightpath and/or for autonomous flight).

Although the following description is primarily given in the context of drones (e.g. quadcopters) moving along a three-dimensional flightpath, certain concepts presented can be applied more generally. For example, the systems and techniques can be applied to non-drone aircraft and/or ground-based vehicles, watercraft and the like.

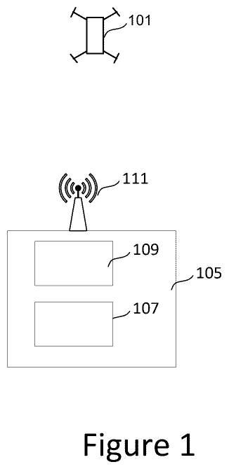

FIG. 1 shows an example of a UAV 101, which is controlled by remote control 105 in this example. Remote control 105 includes a user input interface 107 (e.g. one or more joysticks, buttons, touchpads, touchscreens, keyboards, or other input device(s) configured to receive a user's input). User input interface 107 allows a user to provide appropriate input to control UAV 101 (e.g. by using joysticks to control direction and speed of UAV). Remote control 105 also includes a user output interface 109 (e.g. one or more visual displays, lights, indicators, speakers, or other output devices configured to provide output to a user). For example, a display may show one or more views from camera(s) located on UAV 101 (e.g. a camera providing a pilot's view from UAV 101 to allow FPV operation of UAV 101). In some examples, a UAV may be configured for autonomous operation so that some or all piloting is performed autonomously (e.g. without input from a remote control such as remote control 105). For example, UAV 101 may include a Global Positioning System (GPS) module to determine position or enable independent navigation and/or one or more cameras (e.g. cameras that are paired to form stereoscopic cameras) that may allow UAV 101 to locate features in its environment for navigation.

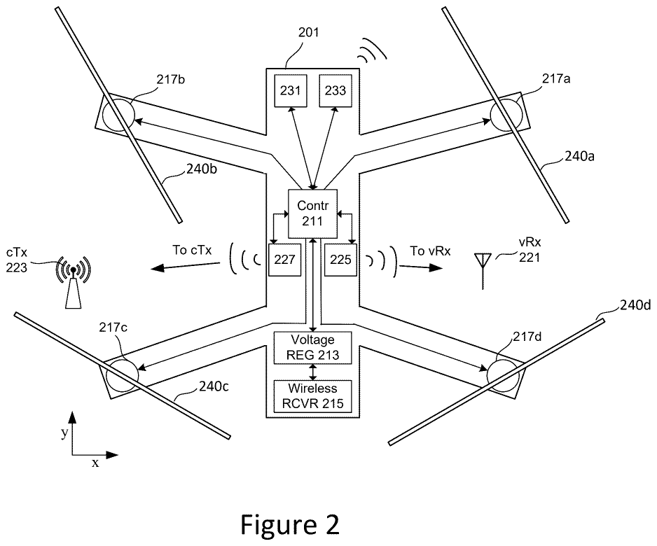

FIG. 2 is simplified representation of some of the components for one example of a UAV 201 (e.g., UAV 101), which is a remote-controlled quadcopter in this example. FIG. 2 shows flight controller 211 connected to motors 217a-d (which turn respective propellers, not shown in this view), the voltage source and regulator 213, wireless receiver 215, video camera 231 and altitude sensor 233, and the transmitters 225 and 227. In this embodiment, extending on an arm from each of the corners of UAV 201 is a motor 217a-d, each of which is controlled by the flight controller 211 to thereby control thrust generated by propellers 240a-d attached to motors 217a-d. FIG. 2 illustrates an example with single bladed propellers, but in other embodiments these can be pairs of counter-rotating propellers. A voltage source (e.g. battery) and regulator 213 supplies power. A pilot's commands are transmitted from control signal transceivers such as cTx 223, received by wireless receiver 215. Control signal transceiver cTx 223 may be in a remote-control operated by a pilot (remote-control user) to fly UAV 201. The flight controller 211 uses power from the voltage source and regulator 213 to drive the motors 217a-d according to the pilot's signals.

UAV 201 also includes video camera 231 and altitude sensor 233 that supply data to the flight controller 211. An FM or other type video transmitter 225 transmits data from the video camera 231 to a video monitor receiver vRx 221 (external to the drone, such as on the ground) that monitors the video signals and passes on the video data to the pilot. Data can also be sent back to the control signal transceiver cTx 223 by the transmitter 227. Although the transmitter 227 and wireless receiver 215 are shown as separate elements in FIG. 2, in many embodiments these will be part of a single transceiver module. And control signal transceiver cTx 223 and video monitor receiver vRx 221 may be part of a single transceiver module. For example, a remote-control, such as remote control 105, may include both a control signal transceiver and a video monitor receiver to allow a remote-control user to see video from video camera 231 while piloting UAV 201.

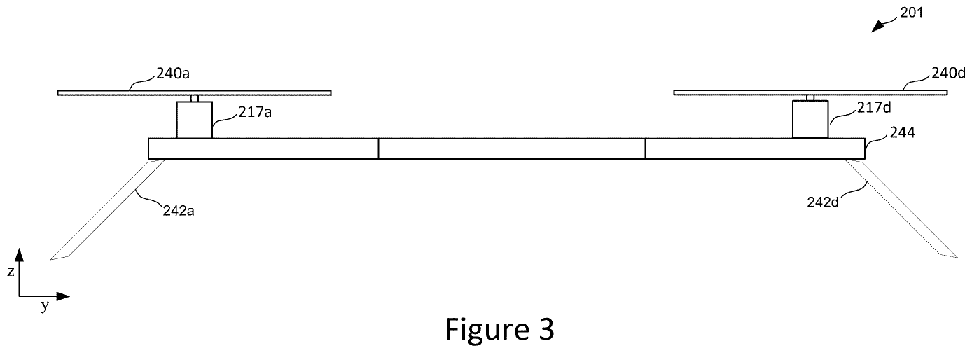

FIG. 3 shows a simplified side-view of UAV 201, which includes motors 217a, 217d (two of four motors 217a-d are visible in this view) and attached propellers 240a, 240d. Also shown are legs 242a and 242d (two of four legs are visible in this view) that are attached to the bottom surface of chassis 244 and support chassis 244 when on the ground. Electric motors 217a-d are mounted to the top surface of chassis 244 and drive corresponding propellers.

In some cases, a UAV such as a drone may be used to transport a payload. A payload may be attached to the UAV in various ways (e.g., bolts, screws, pins, quick-release attachments, clips, mechanical release device, and/or other components). A payload may be passive (e.g., some item to be moved to a different location) or active (e.g., may include electronic components that are active while in-flight).

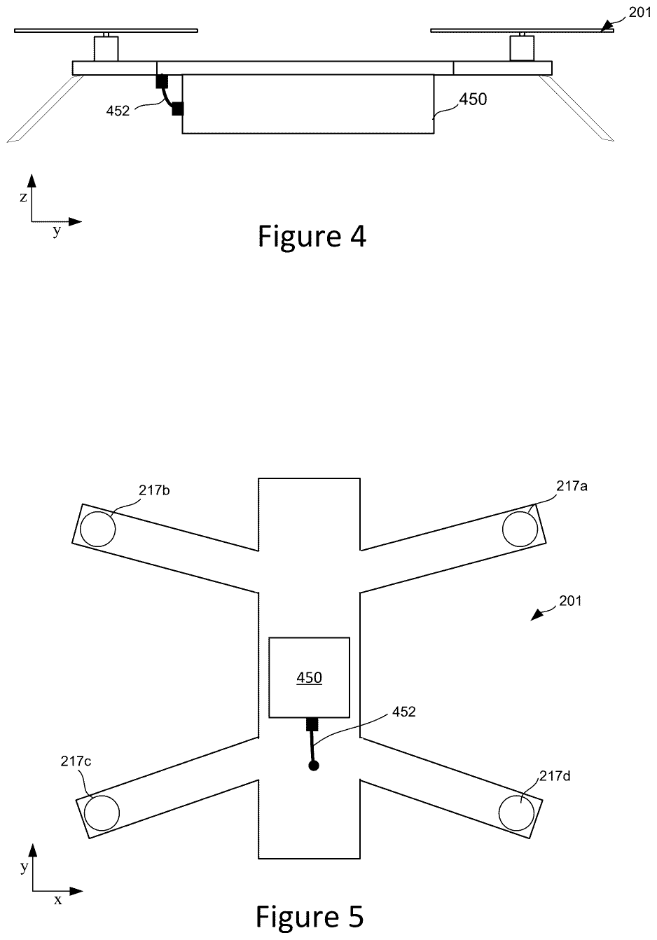

FIG. 4 shows an example of a payload 450 that is attached to UAV 201 so that it may be carried by UAV 201. In this example, payload 450 is an active payload that is electrically connected to UAV 201 by a cable 452 so that it can receive power from UAV 201 (e.g., from voltage source and regulator 213) and can communicate with UAV 201 (e.g., with flight controller 211). Payload 450 may also communicate with a Ground Command System (GCS) through UAV 201 (e.g., through transmitters 225 and 227, wireless receiver 215, or otherwise). In other examples, an active payload may include transmitter and/or receiver circuits so that it can communicate with a GCS independently of the UAV to which it is attached. In some examples, an active payload may include a battery, solar panel, or other energy source and may not require power from a UAV. In some cases, where communication and power are provided in a payload, an electrical connection to the UAV (e.g., cable 452) may not be provided.

FIG. 5 shows a view of UAV 201 (e.g., view from below along the z-direction) with payload 450 attached to its underside. In addition to being mechanically attached to UAV 201 by attachment features (not shown in this view), payload 450 is electrically connected to UAV 201 by cable 452.

In some examples, a UAV payload (e.g., payload 450) may include one or more radio circuits that are designed to receive signals from one or more emitters in order to gather SIGINT. SIGINT platforms are used to collect and analyze Radio Frequency (RF) Signals to provide intelligence on the RF environment. A SIGINT payload (e.g., payload 450 of UAV 201) may include custom hardware and software that allows a user to gather Signals Intelligence and display results through the same Graphical Interface used to control a UAV (e.g., user output interface 109). In some examples, a payload (e.g., SIGINT payload 450) may also send flight commands to the UAV (e.g., to flight controller 211 of UAV 201) which allows the payload to control the flightpath of the UAV to carry out autonomous missions (e.g., without commands from a remote control), for example, in RF Denied locations (e.g., missions in areas where RF signals are jammed, obscured by geography, weather or noise, and/or where use of RF signals would create danger of detection and attack).

The propellers 240a-d of a drone will often extend beyond the main body of a drone, extend the form factor of the drone and making transport more difficult. In order to transport a drone, it would be convenient to be able to remove and readily re-install the propellers. Additionally, the propellers are exposed and relatively delicate components of a drone. For at least these reasons, the ability to readily and easily attach or replace a drone's propellors would be highly beneficial. Unmanned systems traditionally use multiple rotors connected by screws to attach propellers or folding propeller hubs to the drive system. This process necessitates tools, precise torque application, and consumes time. Moreover, rotors have directional requirements that align with the motor's drive direction. To address these problems, the following embodiments present a toolless quick detach mechanism to enable rapid mounting and dismounting of rotary drive effectors, such as propellers for aircraft or boats or robotic actuators. Indexing features allow for “paired” effectors to ensure directionality matches drive configuration. This prevents mismatching of effectors and drives, solving for both the mounting, indexing, and drive of an effector, such as a folding propeller hub. It incorporates specific keyed features for motor directionality and forms a strong mechanical lock resistant to vibration-induced loosening.

More specifically, among the aspects for embodiments of a quick detach keyed rotary drive coupler presented in the following discussion is the use of a locking pin with captive spring and handle for actuation, such as a ball or cam lock. Other aspects include a propellor or other effector hub with features, such as a ramp or screw, to translate between locked and unlocked positions. Additionally, the drive key can be male and female. Further, indexing features such pins or other geometry can act as drive-keying for matching effectors to drives to make sure that the proper propellor or other effector is installed to the proper drive.

A first example embodiment is for a contra-rotating propeller hub. In this embodiment of the design, a dual stacked propeller hub, isolated by bearings for contra-rotation, contains indexing and drive functionality for both propellers. It does so by keying and coupling the top rotor assembly to a square drive rotary pin on the CW (clockwise) drive motor, while utilizing index pins on the CCW (counterclockwise) drive motor to both key and drive the CCW propeller assembly. This embodiment uses the top CW hub to lock the entire assembly in position, while the keyed features allow for contra-rotating drive of the assemblies.

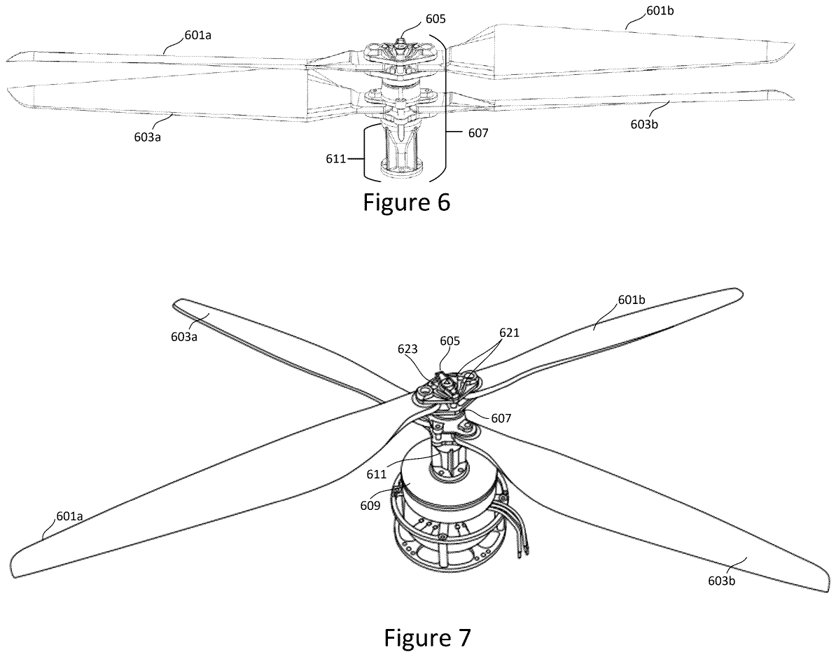

FIG. 6 is a perspective view of an embodiment of a contra-rotating assembly mounted on a drive fixture when not attached to the motor. The upper propeller has blades 601a and 601b and the lower propeller has blades 603a or 603b, with both sets extending laterally from and connected to the propeller drive hub assembly 607 that extends axially to engage with a drive hub mount 611 that is attached to the motor assembly 609. The examples here use two bladed propellers, but other embodiments can use different numbers. As discussed in more detail below, in a contra-rotating embodiment the hub assembly 609 includes a pair of coaxial independently rotatable hubs that are indexed to mount the a correspondingly indexed propeller so that, for example, the clockwise drive motor and the counterclockwise drive motors will only attach the propeller with the correctly oriented blades. Additionally, the assembly can be indexed to differentiate between different motors on a multi-motor drone where different arms or other mounting points might use different propeller sets, such as different rotation directions or sizes.

When mounted to be engaged with the motors, a locking pin can positively held in the “locked” position. This can be achieved with a wave spring connected to a top plate and the locking pin by a retaining ring and is manually advanced to the “open” position by rotating the T-handle 605 of a locking pin through a 90-degree rotation to advance it up a ramp of, for example, 6 mm to allow the locking pin to clear a set steel locking balls, as illustrated in following figures. There are also corresponding ball detents on the top plate which secure the T handle 605 in the “open” position to allow installation on drive hub mount 611 of the motors.

This arrangement allows for the rapid removal and replacement of a damaged propeller assembly with the correct replacement. It also improves portability of the drone by rapid removal and reinstalment of the correct propeller assemblies in the correct location. When installed, the propellers extend beyond the drones frame and, as they can be relatively fragile, can make transporting the drone difficult to transport. For example, in one embodiment, the propellers could have diameter of 32 inches. By removing the propeller assemblies, this results in a more compact package from transport. This portability can further improved in embodiments where, when detached, the blades of a propeller fold together at the hub, effectively reducing the width for transport by half and providing more support to protect them from damage. At the deployment location, the blades can be rapidly unfolded and attached at the corresponding mount due to the indexing of the assemblies.

FIG. 7 is an image of an implementation of the embodiment of FIG. 6 when attached to a motor assembly to form a propeller drive system. More specifically, FIG. 7 repeats the number elements of FIG. 6, but now mounted to a motor 609. In a contra-rotating embodiment, the motor assembly 609 includes two drive motors attached to a coaxial drive where, for example, the lower drive motor drives the upper propeller blades 601a and 601b by way of an inner drive shaft running through an outer drive shaft by which the upper drive motor can drive the lower propeller of blades 603a and 603b. FIG. 7 also numbers the ramps 621 that disengage the propeller assembly when the handle 605 is rotated through 90°and the ball detents 623 that can hold the handle 605 in the unlocked, open position.

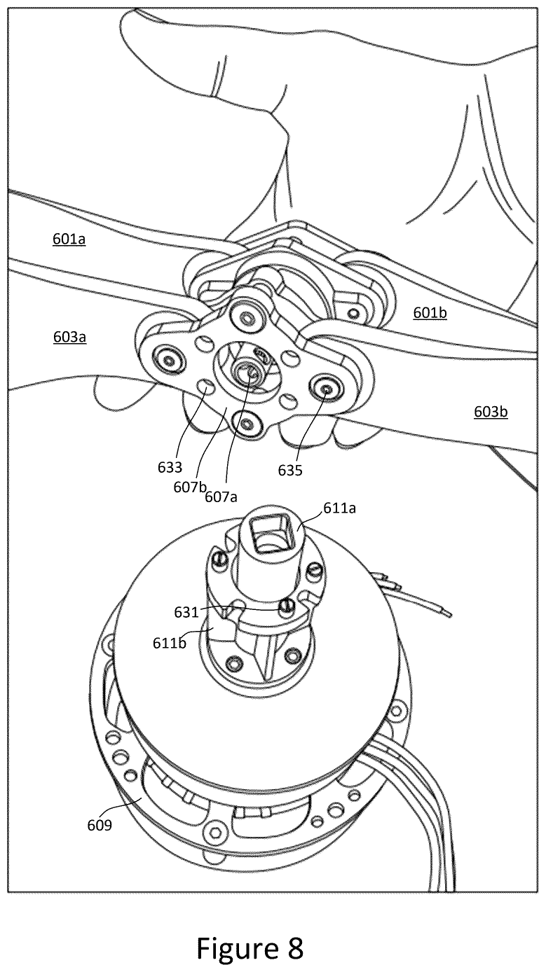

FIG. 8 is a detail of FIG. 7 with the propeller assembly removed from the motor and held to show its underside and with the two propellers aligned. The drive hub mount includes an outer portion 611b for the upper contra-rotating motor of motor pair 609 that drives the outer propeller hub 607b. The outer drive hub 611b has a set of index pins 631 that would, when mounted, engage with the openings 633b of the outer hub 607b to drive the lower propeller of blades 603a, 603b in, for example, a counter-clockwise direction. Different propellers assemblies can be indexed to only mount to the corresponding motor by use of different indexing pin arrangements. FIG. 8 also has an outer portion 611a of the drive hub mount for the lower contra-rotating motor of motor pair 609 can independently drive the inner propeller hub 607a. The inner drive hub 611a is here a female square mount that would, when mounted, engage with the rectangular male shaft of the inner hub 607a to drive the upper propeller of blades 601a, 601b in, for example, a clockwise direction. Different propellers assemblies can be indexed to mount the corresponding lower motor by use different indexing shapes. FIG. 8 also illustrates the pivots, such a at 635, that can allow the disengaged assembly to have its blades rotated 90° inwards so that they align and reduce the assembly stowed size length by half.

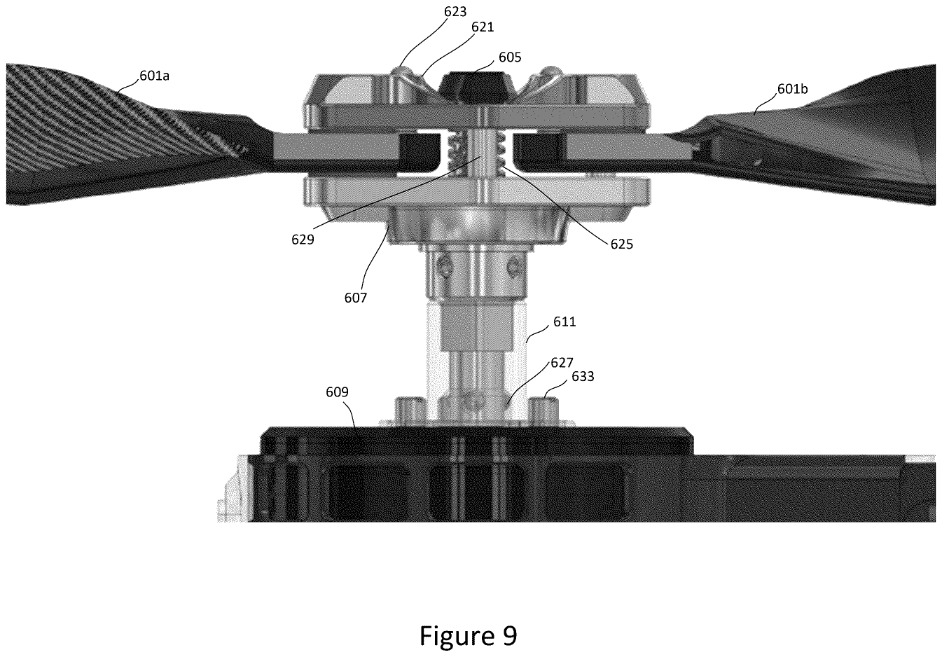

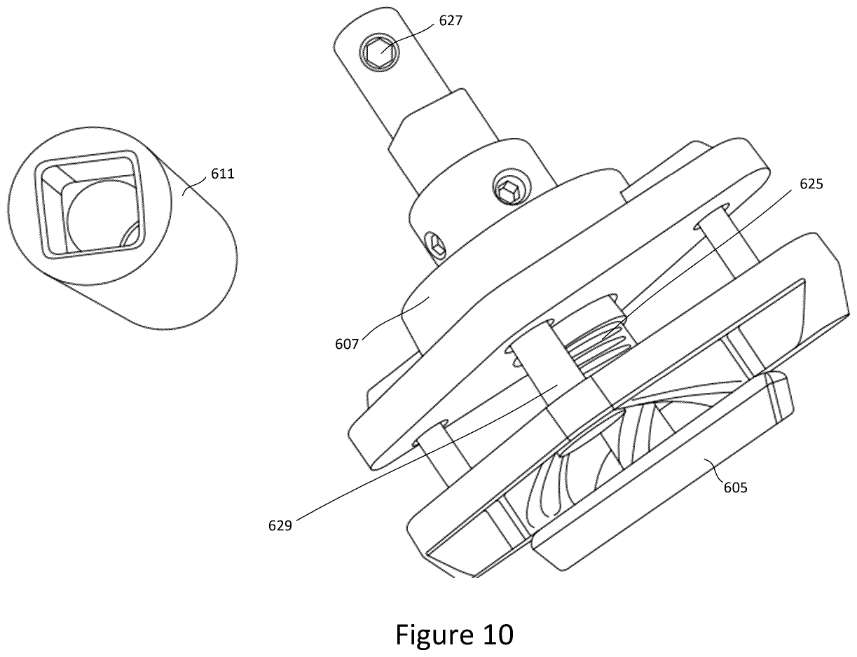

FIG. 9 is a transparent view of assembly engaged with square drive shaft for a single propellor and single motor, where this could either be a single propeller embodiment or a contra-rotating embodiment with only one propeller with blades 601a, 601b and one motor presented 609. In the single propeller example, the square drive of the propeller hub 607 is engaged with the drive hub 611 mounted by bolts 633 to the motor 609. In a contrarotating example, the second propeller and much of its hub would not be shown and the transparent element labelled 611 of FIG. 9 could correspond to part of 607b FIG. 8 and the elements 633 could correspond to the indexing pins 631. In either case, the element labelled 611 is transparent to illustrate how propellor assembly engages.

In FIG. 9, the T-handle 605 is in the engaged, or locked, position, oriented to run into the page in this view. With respect to the other elements of the engagement mechanism, extending downward from the T-handle 605 is connected a central inner rod or shaft 629 extending axially downward through the hub assembly 607. A captive wave spring 625 pulls the handle 605 downward through the hub assembly 607 to thereby force outward the captive balls 627 to act as an engagement mechanism to hold the propeller assembly engaged with the drive hub 611. By rotating T-handle 605 90° it is pulled up the ramps 621 to lock in place by the ball detents 623, allowing the shaft 629 to move upward and allow the captive balls 627 to move inward and release the propeller assembly.

FIG. 10 is an image of the propeller assembly hub and the motor assembly drive hub elements when disengaged. More specifically, the propeller assembly hub structure 607 is shown with the propeller blades removed, with the drive hub 611 shown at left. The central hub assembly illustrates the T-handle 605 is shown in the unlocked or open position, rotated up the ramp structure to extend the wave spring 625 and allow the central shaft 629 to move upward and allow the captive balls 627 to retract into the hub structure 607 to allow disengagement from the drive hub 611.

In the “open” position, this assembly can be inserted into or extracted from the hollow shaft 611 of the drive assembly, which contains both a square drive (female) feature as well as cylindrical recesses to lock the pin in place by means of mechanical interference created with, for example 3 5 mm captive steel balls 627. Referring back to FIG. 8, the lower hub (e.g., CCW) keys 607b can key and index on the cylindrical drive pins 631. This provides the lower motor to drive the CCW propeller assembly with blades 603a, 603b, while the (CW) top assembly containing the pin holds all parts in place.

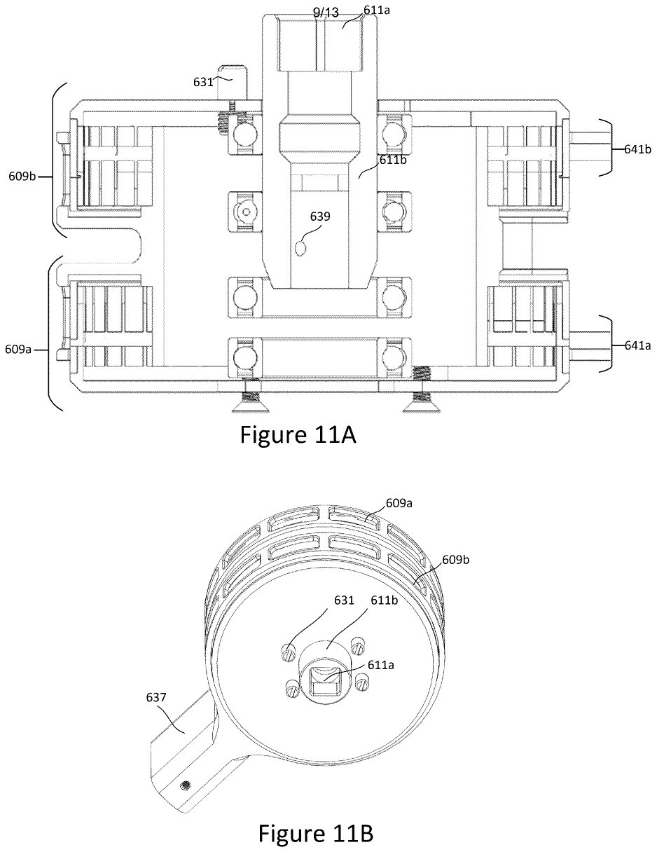

FIGS. 11A and 11B are respectively side and perspective views of an embodiment of the drive motor showing 4× lower index drive pins, square drive shaft, and recess in the shaft for locking pin engagement. In the cutaway side view of FIG. 11A, the lower of the coaxial contra-rotating drive motors 609a drives the inner drive hub 611a with the square drive based on power and control signals received on lines 641a. Inside of the inner drive hub, indents such as indicated at 639 act as an engagement element to receive the captive steel balls 627 when the propeller assembly is engaged. Similarly, the upper contra-rotating drive motor 609b drives the outer drive hub 611b based on power and control signals received on lines 641b. Only a single indexing pin 631 is shown FIG. 11A. The top perspective view of FIG. 11B shows all a set of indexing pins 631, as well as the motor pair 609a, 609b and drive hubs 611a, 611b. The motors are shown attached an arm 637 of the drone through which the power and control lines 641a, 641b.

Due to the cylindrical locking pin geometry of the propeller assembly, it becomes very simple to integrate the passive locking and drive features into the motor drive itself. Brushless motor drives often feature a hollow central shaft which can be easily modified to add the necessary geometry to accommodate drive hubs 611a, 611b. This results in a net weight savings of the paired drive and propeller assembly, by removing the need to screw on any kind of quick detach adapter plate.

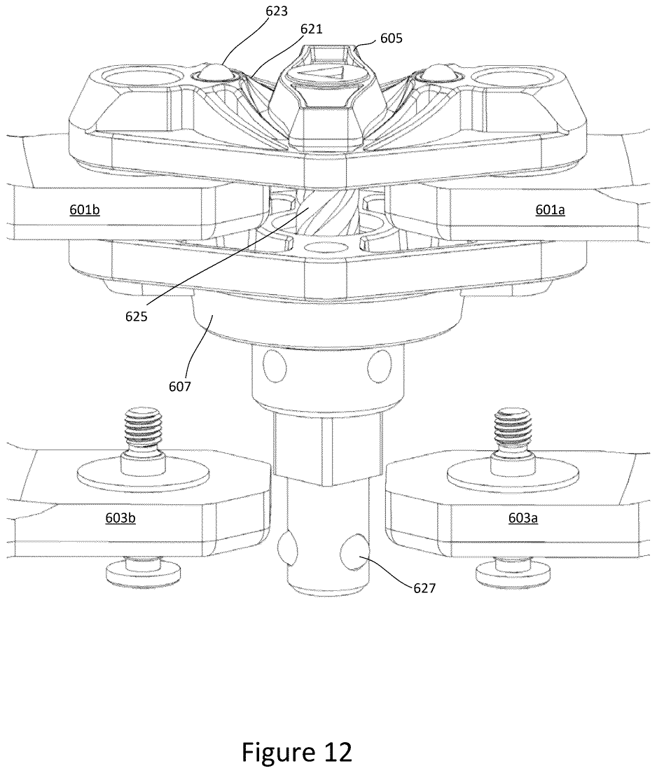

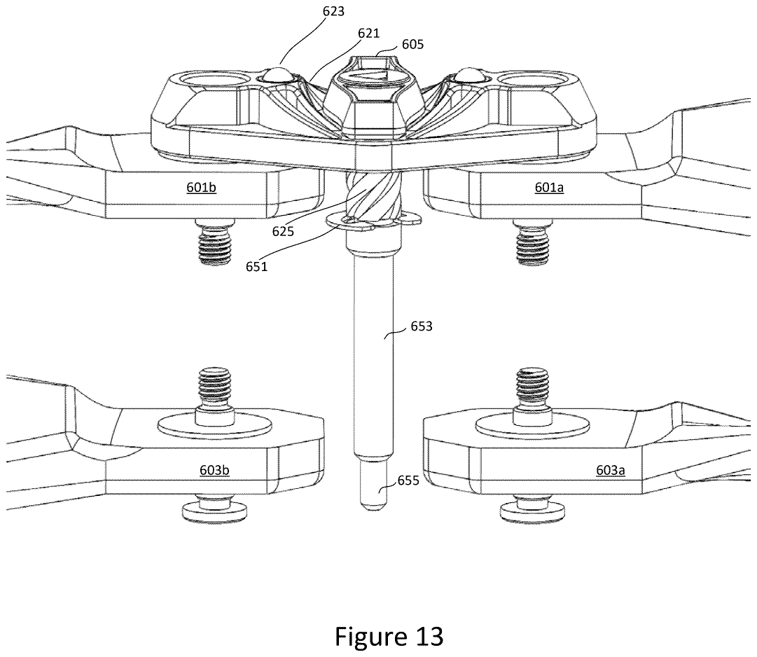

FIG. 12 is a perspective view of the assembly featuring square drive, locking pin, and twist to unlock T-handle pin with the lower blades 603a, 603b and the portions of the assemble specific the lower blades removed. The T-handle 605 is shown in the locked position where it is pulled down by the wave spring 625 so that the internal shaft 653 forces outward the captive balls 627 into the indents 639 of FIG. 11A to act as the engagement mechanism for the propeller assembly, where alternate embodiments can use a cam arrangement. Rotating the T-handle 605 by a quarter turn takes it up the ramps 621, where it can be held in the open position by the ball detents 623. This pulls up the internal rod and allows the captive balls 627 to retract, where the internal rod is illustrated in FIG. 13. In alternate embodiments, with a different geometry for the inner rod, the raised position could be the locked position and the lower position could be the released position, such as by having a recessed region in the inner rod for this purpose.

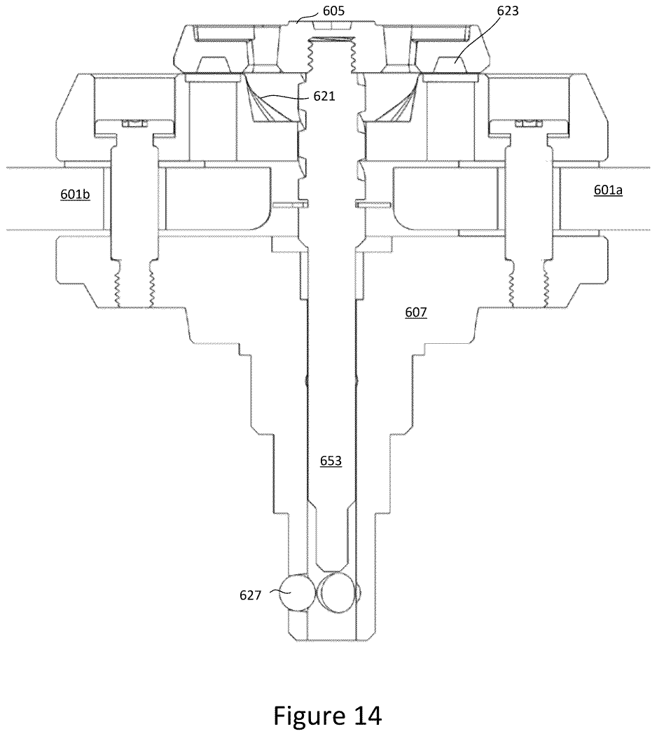

FIG. 13 is a perspective view of the twist lock pin in the “locked” position, held in place by captive wave spring 625 and retaining ring 651. Relative to FIG. 12, additional portion of the assembly have been removed to illustrate the internal rod 653 attached to the T-handle 605 that is again in the lower locked position. The retaining ring 651 is located on the interval rod 653 to tension the wave spring 625 and hold the T-handle 605 fully downward to push outward the captive balls 627 with the lower portion 655. When the T-handle 605 is rotated up the ramp 621, the inner rod 653 is in a raised position, removing the lower portion 655 from between the captive balls 627, which can then move inward as illustrated in FIG. 14.

FIG. 14 is a cutaway view of the assembly in the “unlocked” position. Relative to FIGS. 12 and 13, the T-handle 605 has been twisted 90 degrees, translating up a ramp feature 621 and being held in place by the ball detents 623. This compresses the wave spring and raises up the internal rod 653, and clearing the locking balls 627 at the bottom of the pin and allowing them to move inward and release the propeller assembly.

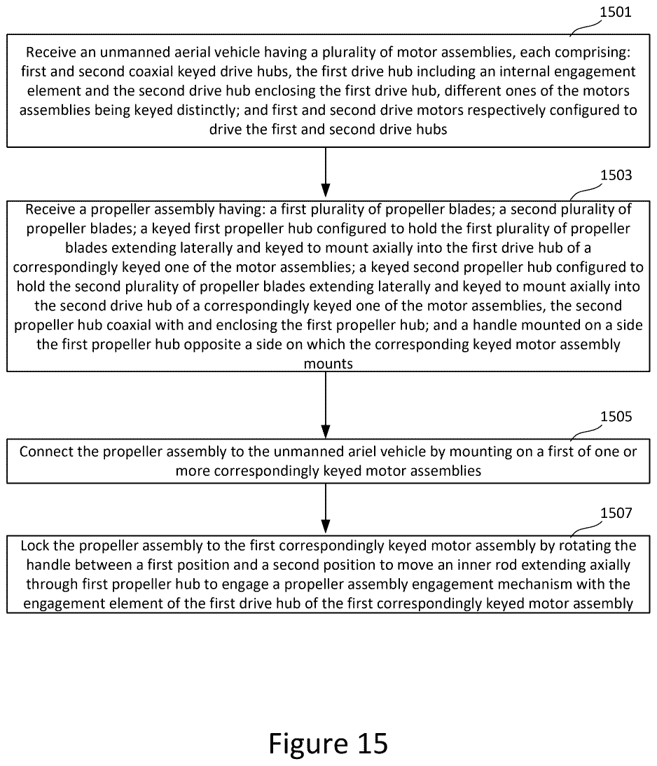

FIG. 15 is a flow chart of an embodiment for operating of an unmanned aerial vehicle such as the quadcopter embodiments of FIGS. 1-5, with a quick detach keyed rotary drive coupler such as presented in FIGS. 6-14. This method can be performed as part of replacing a defective propellor assembly or as part of deploying a drone by installing propellers that have been removed for transporting the drone in a more compact stowed configuration with the propellers removed. At step 1501, an unmanned aerial vehicle having a plurality of motor assemblies, where these motors can be as described above with respect to FIGS. 11A and 11B having coaxial inner and outer keyed drive hubs 611a, 611b, where the inner drive hub includes an internal engagement element and the second drive hub enclosing the first drive hub, different ones of the motors assemblies being keyed distinctly. The motor assemblies each include first and second drive motors 609a, 609b are respectively configured to drive the coaxial inner and outer keyed drive hubs 611a, 611b.

At step 1503, which can before, after, or concurrent with step 1501, a propeller assembly is received. As shown in the embodiments of FIGS. 6-10 and 12-15, the assembly can include first and second sets of propeller blades 601a, 601b and 603a, 603b and a coaxial keyed propeller hubs 607a, 607b from which the blades (when not folded) extend laterally and which extends axially to mount to a correspondingly keyed one of the motor assemblies. The propellor assembly also includes a handle 605 that can be rotated to either lock or detach the propeller assembly from the corresponding motor assembly.

At step 1505 the propeller assembly is connected to the unmanned ariel vehicle by mounting on a first of one or more correspondingly keyed motor assemblies. At step 1507, the propeller assembly is locked to the first correspondingly keyed motor assembly by rotating the handle between a first position and a second position to move an inner rod extending axially through first propeller hub to engage a propeller assembly engagement mechanism with the engagement element of the first drive hub of the first correspondingly keyed motor assembly.

A number of variations can be incorporated in the embodiments presented above. For example, secondary locking features can be included to prevent accidental actuation and decoupling of the mechanism. To add in aligning keyed parts, magnets or improved indexing features can be added. Tactile indicators (i.e., geometry) can be added to convey keyed pairs, such as for a clockwise/contra-clockwise example. To allow keyed indexing and coupling of effectors requiring data or power transfer between host and effector, electrical connectors can be added. Further embodiments can add dampening features to further minimize vibration in assembly.

In a first set of aspects, an unmanned aerial vehicle comprises one or more motor assemblies and one or more propeller assemblies. Each motor assembly includes a keyed first drive hub with an internal engagement element and a first drive motor configured drive the first drive hub. Each propeller assembly includes: a first plurality of propeller blades; a keyed first propeller hub configured to hold the first plurality of propeller blades extending laterally and keyed to mount axially into the first drive hub of a correspondingly keyed one of the motor assemblies; an inner rod extending axially through first propeller hub; a handle mounted on a side the first propeller hub opposite a side on which the corresponding keyed motor assembly mounts and attached to the inner rod; a ramp structure on the side of first propeller hub opposite the side on which the corresponding keyed motor assembly mounts; and a propeller assembly engagement mechanism. The ramp structure is configured to move the inner rod between a lowered position and a raised position in response to rotating the handle between a first position and a second position. The propeller assembly engagement mechanism is configured to: engage with the engagement element of the first drive hub of the correspondingly keyed motor assembly to lock the first propeller hub thereto when the inner rod is in one of the raised position and the lowered position; and release the first propeller hub from first keyed drive hub of the correspondingly keyed motor assembly when the inner rod is in the other of the raised position and the lowered position.

In additional aspects, a propeller drive system comprises a motor assembly and propeller assembly detachably connectable to the motor assembly. The motor assembly includes a first and a second coaxial keyed drive hubs, the first drive hub including an internal engagement element and the second drive hub enclosing the first drive hub; and first and second drive motors respectively configured to drive the first and second drive hubs. The propeller assembly can include: a first plurality of propeller blades; a second plurality of propeller blades; a keyed first propeller hub configured to hold the first plurality of propeller blades extending laterally and keyed to mount axially into the first drive hub of a correspondingly keyed one of the motor assemblies; a keyed second propeller hub configured to hold the second plurality of propeller blades extending laterally and keyed to mount axially into the second drive hub of a correspondingly keyed one of the motor assemblies, the second propeller hub coaxial with and enclosing the first propeller hub; an inner rod extending axially through first propeller hub; a handle mounted on a side the first propeller hub opposite a side on which the corresponding keyed motor assembly mounts and attached to the inner rod; a ramp structure on the side of first propeller hub opposite the side on which the corresponding keyed motor assembly mounts, the ramp structure configured to move the inner rod between a lowered position and a raised position in response to rotating the handle between a first position and a second position; and a propeller assembly engagement mechanism configured to: engage with the engagement element of the first drive hub of the correspondingly keyed motor assembly to lock the first propeller hub thereto when the inner rod is in one of the raised position and the lowered position; and release the first propeller hub from first keyed drive hub of the correspondingly keyed motor assembly when the inner rod is in the other of the raised position and the lowered position.

In further aspects, a method of operating an unmanned aerial vehicle includes: receiving an unmanned aerial vehicle having a plurality of motor assemblies, each comprising first and second coaxial keyed drive hubs, the first drive hub including an internal engagement element and the second drive hub enclosing the first drive hub, different ones of the motors assemblies being keyed distinctly and first and second drive motors respectively configured to drive the first and second drive hubs; and receiving a propeller assembly, comprising: a first plurality of propeller blades; a second plurality of propeller blades; a keyed first propeller hub configured to hold the first plurality of propeller blades extending laterally and keyed to mount axially into the first drive hub of a correspondingly keyed one of the motor assemblies; a keyed second propeller hub configured to hold the second plurality of propeller blades extending laterally and keyed to mount axially into the second drive hub of a correspondingly keyed one of the motor assemblies, the second propeller hub coaxial with and enclosing the first propeller hub; and a handle mounted on a side the first propeller hub opposite a side on which the corresponding keyed motor assembly mounts. The method also includes: connecting the propeller assembly to the unmanned ariel vehicle by mounting on a first of one or more correspondingly keyed motor assemblies; and locking the propeller assembly to the first correspondingly keyed motor assembly, including rotating the handle between a first position and a second position to move an inner rod extending axially through first propeller hub to engage a propeller assembly engagement mechanism with the engagement element of the first drive hub of the first correspondingly keyed motor assembly.

For purposes of this document, it should be noted that while various examples are given with specific combinations of components and specific configurations, in general, components used in one example may also be used in other examples and configurations may be combined.

For purposes of this document, it should be noted that the dimensions of the various features depicted in the figures may not necessarily be drawn to scale.

For purposes of this document, reference in the specification to “an embodiment,” “one embodiment,” “some embodiments,” or “another embodiment” may be used to describe different embodiments or the same embodiment.

For purposes of this document, a connection may be a direct connection or an indirect connection (e.g., via one or more other parts). In some cases, when an element is referred to as being connected or coupled to another element, the element may be directly connected to the other element or indirectly connected to the other element via intervening elements. When an element is referred to as being directly connected to another element, then there are no intervening elements between the element and the other element. Two devices are “in communication” if they are directly or indirectly connected so that they can communicate electronic signals between them.

For purposes of this document, the term “based on” may be read as “based at least in part on.”

For purposes of this document, without additional context, use of numerical terms such as a “first” object, a “second” object, and a “third” object may not imply an ordering of objects, but may instead be used for identification purposes to identify different objects.

For purposes of this document, the term “set” of objects may refer to a “set” of one or more of the objects.

The foregoing detailed description has been presented for purposes of illustration and description. It is not intended to be exhaustive or to limit to the precise form disclosed. Many modifications and variations are possible in light of the above teaching. The described embodiments were chosen in order to best explain the principles of the proposed technology and its practical application, to thereby enable others skilled in the art to best utilize it in various embodiments and with various modifications as are suited to the particular use contemplated. It is intended that the scope be defined by the claims appended hereto.

1. An unmanned aerial vehicle, comprising:
one or more motor assemblies, each comprising:
a keyed first drive hub with an internal engagement element; and
a first drive motor configured drive the first drive hub; and
one or more propeller assemblies, each comprising:
a first plurality of propeller blades;
a keyed first propeller hub configured to hold the first plurality of propeller blades extending laterally and keyed to mount axially into the first drive hub of a correspondingly keyed one of the motor assemblies;
an inner rod extending axially through first propeller hub;
a handle mounted on a side the first propeller hub opposite a side on which the corresponding keyed motor assembly mounts and attached to the inner rod; and
a ramp structure on the side of first propeller hub opposite the side on which the corresponding keyed motor assembly mounts, the ramp structure configured to:
move the inner rod between a lowered position and a raised position in response to rotating the handle between a first position and a second position; and
a propeller assembly engagement mechanism configured to:
engage with the engagement element of the first drive hub of the correspondingly keyed motor assembly to lock the first propeller hub thereto when the inner rod is in one of the raised position and the lowered position; and
release the first propeller hub from first keyed drive hub of the correspondingly keyed motor assembly when the inner rod is in the other of the raised position and the lowered position.

2. The unmanned aerial vehicle of claim 1, wherein the internal engagement element of the first drive hub includes a plurality of indents, and
wherein the propeller assembly engagement mechanism includes a corresponding plurality of metal balls captive in the first propeller hub and forced into the indents when the first propeller hub is locked to the first drive hub of the correspondingly keyed motor assembly.

3. The unmanned aerial vehicle of claim 2, wherein the first propeller hub is locked to the first drive hub of the correspondingly keyed motor assembly when the inner rod is in the lowered position.

4. The unmanned aerial vehicle of claim 1, wherein, when engaged, the first propeller hub fits inside of the first drive hub and are keyed based on a shape the first propeller hub and a corresponding shape the first drive hub.

5. The unmanned aerial vehicle of claim 1, wherein the first drive hub includes a plurality of pins, the first propeller hub includes a corresponding plurality of pin openings, and, when engaged, the pins fit inside of the pin openings and are keyed based on an arrangement of the pins.

6. The unmanned aerial vehicle of claim 1, wherein each of the one or more motor assemblies further comprise:
a keyed second drive hub coaxial with and enclosing the first drive hub; and
a second drive motor configured drive the second drive hub, the first drive motor and the second drive motor being contra-rotating with respect to one another; and
wherein each of the one or more propeller assemblies further comprise:
a second plurality of propeller blades; and
a keyed second propeller hub configured to hold the second plurality of propeller blades extending laterally and keyed to mount axially into the second drive hub of a correspondingly keyed one of the motor assemblies, the second propeller hub coaxial with and enclosing the first propeller hub.

7. The unmanned aerial vehicle of claim 6, wherein the first propeller hub and the second propeller hub are keyed differently.

8. The unmanned aerial vehicle of claim 1, wherein each of the one or more propeller assemblies further comprise:
one or more ball detents on the side of first propeller hub opposite the side on which the corresponding keyed motor assembly mounts configured to hold the handle in the second position.

9. The unmanned aerial vehicle of claim 1, wherein each of the one or more propeller assemblies further comprise:
a spring configured to hold the handle in the first position.

10. The unmanned aerial vehicle of claim 1, wherein rotating the handle between a first position and a second position is rotating the handle by 90 degrees.

11. The unmanned aerial vehicle of claim 1, wherein the first plurality of propeller blades are foldable when the first propeller hub is released.

12. The unmanned aerial vehicle of claim 1, wherein the one or more motor assemblies are a plurality of motor assemblies and the one or more propeller assemblies are a plurality of propeller assemblies.

13. The unmanned aerial vehicle of claim 12, wherein the first drive hub of each of the plurality of motor assemblies are each keyed differently.

14. The unmanned aerial vehicle of claim 12, further comprising:
a control circuit connected to the plurality of motor assemblies to provide power to and independently operate each of the plurality of motor assemblies.

15. A propeller drive system, comprising:
a motor assembly, comprising:
first and second coaxial keyed drive hubs, the first drive hub including an internal engagement element and the second drive hub enclosing the first drive hub; and
first and second drive motors respectively configured to drive the first and second drive hubs; and
a propeller assembly detachably connectable to the motor assembly, comprising:
a first plurality of propeller blades;
a second plurality of propeller blades;
a keyed first propeller hub configured to hold the first plurality of propeller blades extending laterally and keyed to mount axially into the first drive hub of a correspondingly keyed one of the motor assemblies;
a keyed second propeller hub configured to hold the second plurality of propeller blades extending laterally and keyed to mount axially into the second drive hub of a correspondingly keyed one of the motor assemblies, the second propeller hub coaxial with and enclosing the first propeller hub;
an inner rod extending axially through first propeller hub;
a handle mounted on a side the first propeller hub opposite a side on which the corresponding keyed motor assembly mounts and attached to the inner rod;
a ramp structure on the side of first propeller hub opposite the side on which the corresponding keyed motor assembly mounts, the ramp structure configured to:
move the inner rod between a lowered position and a raised position in response to rotating the handle between a first position and a second position; and
a propeller assembly engagement mechanism configured to:
engage with the engagement element of the first drive hub of the correspondingly keyed motor assembly to lock the first propeller hub thereto when the inner rod is in one of the raised position and the lowered position; and
release the first propeller hub from first keyed drive hub of the correspondingly keyed motor assembly when the inner rod is in the other of the raised position and the lowered position.

16. The propeller drive system of claim 15, wherein the first propeller hub and the second propeller hub are keyed differently.

17. The propeller drive system of claim 16, wherein, when engaged, the first propeller hub fits inside of the first drive hub and are keyed based on a shape the first propeller hub and a corresponding shape the first drive hub, and
wherein the second drive hub includes a plurality of pins, the second propeller hub includes a corresponding plurality of pin openings, and, when engaged, the pins fit inside of the pin openings and are keyed based on an arrangement of the pins.

18. The propeller drive system of claim 15, wherein the internal engagement element of the first drive hub includes a plurality of indents, and
wherein the propeller assembly engagement mechanism includes a corresponding plurality of metal balls captive in the first propeller hub and forced into the indents when the first propeller hub is locked to the first drive hub of the correspondingly keyed motor assembly.

19. The propeller drive system of claim 15, wherein the first plurality of propeller blades and the second plurality of propeller blades are foldable when the first propeller hub is released.

20. A method of operating an unmanned aerial vehicle, comprising:
receiving an unmanned aerial vehicle having a plurality of motor assemblies, each comprising:
first and second coaxial keyed drive hubs, the first drive hub including an internal engagement element and the second drive hub enclosing the first drive hub, different ones of the motors assemblies being keyed distinctly; and
first and second drive motors respectively configured to drive the first and second drive hubs; and
receiving a propeller assembly, comprising:
a first plurality of propeller blades;
a second plurality of propeller blades;
a keyed first propeller hub configured to hold the first plurality of propeller blades extending laterally and keyed to mount axially into the first drive hub of a correspondingly keyed one of the motor assemblies;
a keyed second propeller hub configured to hold the second plurality of propeller blades extending laterally and keyed to mount axially into the second drive hub of a correspondingly keyed one of the motor assemblies, the second propeller hub coaxial with and enclosing the first propeller hub; and
a handle mounted on a side the first propeller hub opposite a side on which the correspondingly keyed motor assembly mounts;
connecting the propeller assembly to the unmanned ariel vehicle by mounting on a first of one or more correspondingly keyed motor assemblies; and
locking the propeller assembly to the first correspondingly keyed motor assembly by rotating the handle between a first position and a second position to move an inner rod extending axially through first propeller hub to engage a propeller assembly engagement mechanism with the engagement element of the first drive hub of the first correspondingly keyed motor assembly.
